(19) United States
(12) Patent Application Publication
(10) Pub. No.: US 2022/0019978 A1
(43) Pub. Date: Jan. 20, 2022

(54) Job Application System and Method

(71) Applicant: David Levinbook, New York, NY (US)

(72) Inventor: David Levinbook, New York, NY (US)

(21) Appl. No.: 17/377,289

(22) Filed: Jul. 15, 2021

Related U.S. Application Data
(60) Provisional application No. 63/052,438, filed on Jul. 15, 2020.

(51) Int. Cl. G06Q 10/10

(52) U.S. Cl. CPC G06Q 10/1053; G06Q 10/103

(57) ABSTRACT

A job application system and method comprising receiving an application from a job candidate for an open position in response to a job posting, the job posting accessible on a job posting platform accessible on a personal computing device connected to an electronic network. The job posting including textual content and graphic content. In a preferred embodiment, the graphic content includes one or more pictorial interactive organizational charts. Using a prescreening algorithm, accepting or rejecting the application based on preset prescreening criteria. Notifying the job candidate on the acceptance or rejection.

### BACKGROUND OF THE INVENTION

### Field of the Invention

The present invention relates generally to job application systems and methods, and more particularly to a job application system and method featuring interactive pictorial organizational charts providing greater visibility into an organization and its teams.

### Related Art

Research has shown that majority of job seekers are motivated by the idea of being a part of a team and that they generally identify more with their team than with the company itself. With remote work on the rise, in-person connections may be limited to annual and semi-annual company gatherings, in such instances, there is a need for encouraging and maintaining meaningful connections throughout organizations and for greater transparency throughout the hiring and internal resource allocation processes.

Presently in the art, job postings provide little to no insight into the team members that a job candidate may work with if they were to secure a specific role. The typical job posting consists solely of a generic textual description of the role and required qualifications. This type of flat job description alone has been proven to be uncompelling and antiquated. A large percentage of job seekers are choosing not to apply to job postings which provide no meaningful insight into the culture of the team and/or organization. Without having a deeper context into a role, the anatomy of the team, the team's position in relation to the rest of the organization, and the background of its members including their likes, hobbies, interests and overall team culture, there is an increased risk that both the new hire and the employer will waste valuable time during the interview process. There is also an increased possibility of hiring a candidate that is a bad fit, thereby increasing employee turnover and other human resources related issues.

What is needed is a system and method for providing job candidates with greater visibility into an organization and into the potential team members they may work closely with should they secure a specific role, during the initial stages of the hiring process. The present invention relates to internal and external hiring and more particularly to a system and method providing visibility into the makeup and structure of teams and their team members during the hiring process. The present invention provides a platform for teams to communicate work achievements throughout the organization and provide greater transparency into projects being worked on. This level of transparency creates more cohesive and successful teams thereby improving corporate morale.

### SUMMARY OF THE INVENTION

The present invention discloses a job application system and method providing job candidates with internal visibility into the teams that they may work with should they secure a specific role. Further, the invention allows employees to easily apply for other roles within the organization and to recommend internal and external candidates for roles. The system and method comprising receiving an application from a job candidate for an open position response to a job posting, the job posting accessible on a job posting platform accessible on a personal computing device connected to an electronic network. The job posting including textual content and graphic content. In a preferred embodiment, the graphic content includes one or more pictorial interactive organizational charts. Using a prescreening algorithm, accepting or rejecting the application based on preset prescreening criteria. Notifying the job candidate on the acceptance or rejection.

These and other aspects of the present invention will become readily apparent upon further review of the specification and drawings.

### BRIEF DESCRIPTION OF THE DRAWINGS

Embodiments of the present invention will be described by way of example only, and not limitation, with reference to the accompanying drawings.

FIG. 1 is a flow diagram illustrating the system and method as it relates to an internal and external job candidate;

FIG. 2 is an exemplary system architecture for implementing the present system and method; and

FIG. 3 is an exemplary user screen showing one or more interactive organizational charts.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention.

The present invention discloses a job application system and method improving the job application process for candidates and assisting an administrative user in managing the job application process. The system may include a system server in communication with one or more personal computing devices and one or more administrative user computing devices over a data network. One or more databases may be in direct communication with the system server. The system server may be a processor-based computing system capable of executing instructions stored in one or more memories. The processor-based computing system may be comprised of a single computing machine or a collection of computing machines. A collection of computing machines may individually or jointly execute sets of instructions stored in one or more memories.

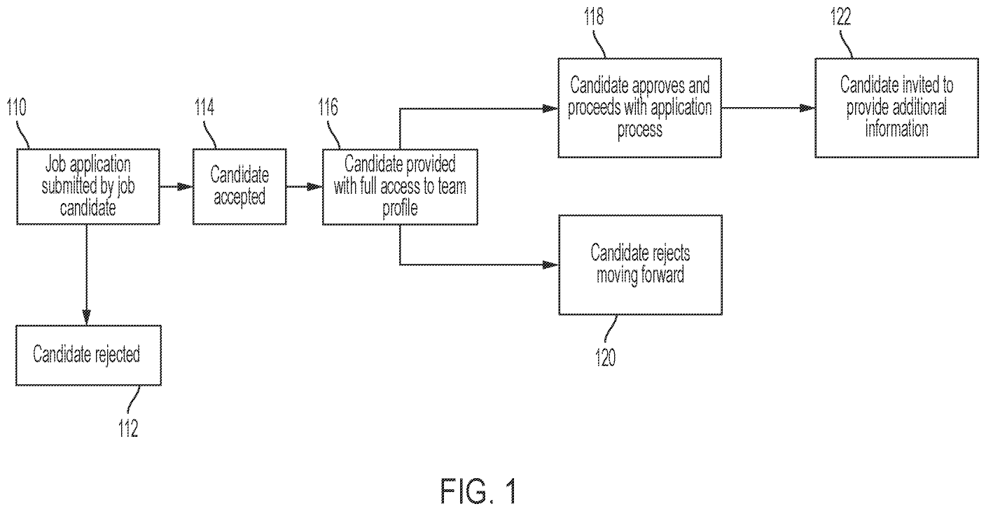

Referring to the figures where similar reference characters denote similar elements throughout the figures, FIG. 1 is a flow diagram illustrating the present system and method as it relates to a job candidate.

Turning first to an external job candidate. An external job candidate views a job posting comprising of at least textual content such as a job description and required qualifications on their computing device. The job posting may also comprise of a graphic content. The computing device may be a mobile device, desktop device, handheld computing device, or other personal computing device. The personal computing device having output functionality (e.g., display monitor, touchscreen, etc.) and input functionality (e.g., touchscreen, keyboard, mouse, etc.). The job posting may be viewed by the external job candidate on an employer's website, a third-party job board, a staffing agency's website or by any other means commonly known for viewing job postings, accessible by the candidate through their computing device connected to an electronic, network, such as the internet and/or other communications networks known in the art. For ease of description only, these aforementioned websites/platforms will hereafter be referred to collectively as “Job Posting Platforms.” The job Posting Platforms in communication with the job application system using application programming interfaces (APIs).

The candidate submits an application for the job 110 which is either automatically denied 112 or accepted 114 based on certain preset prescreening criteria using a prescreening algorithm. The preset prescreening criteria are predetermined by an administrative user and are stored in one or more databases. If the application is accepted 114, the candidate is provided access to a team profile 116. The team profile including information about the team members that the external job candidate would work closely with should they be hired for the posted role. The team profile including images of team members, titles, biographies, videos, skillsets, achievements, hobbies and other personal interests, current and past projects.

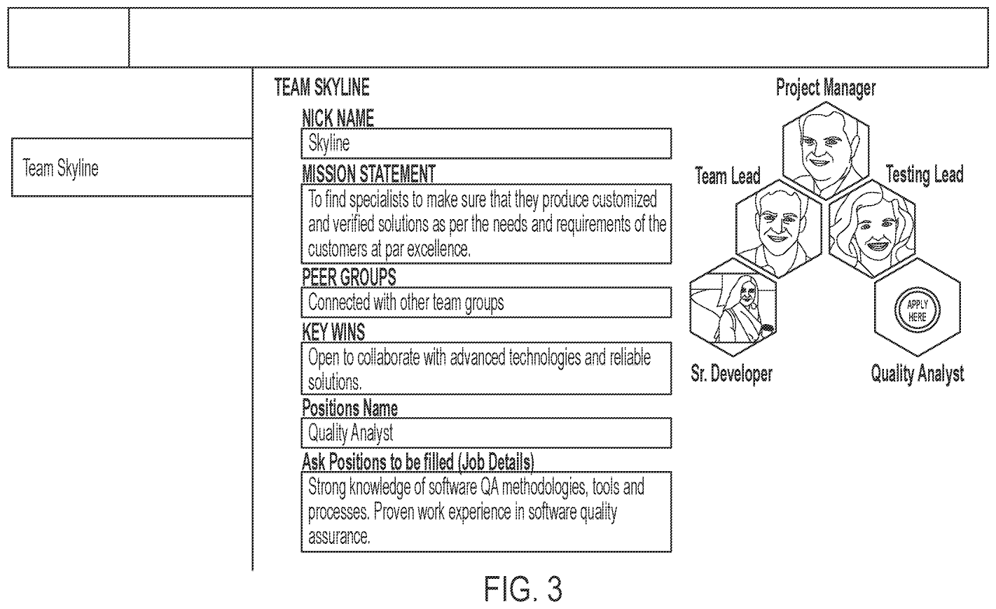

In a preferred embodiment of the present invention the team profile is laid out as one or more interactive pictorial organizational charts. At least one of the one or more interactive pictorial organizational charts identifies only the members on that specific team and allows candidates and other viewers to click on a team member's profile to learn more about their role, skillsets, projects, hobbies and to correspond with the team members and/or the organization. The team profile may also show open roles on the team mild allow application to those roles directly through the team profile, as shown in FIG. 3. In some embodiments on the invention, one of the one or more interactive pictorial organizational charts is the company wide organizational chart allowing candidates to see where that specific team fits into the rest of the organization.

Upon viewing the team profile, the candidate has the option to approve moving forward with the application process 118 or reject moving forward with the application process 120. The option to accept or reject moving toward with the process may appear to the candidate as graphic buttons or other selectable elements displayed on the screen of the candidate's computing device. If the candidate approves moving forward with the application process, the candidate is automatically invited by the job application system to provide additional information to the administrative user 122. This invitation may be in the form of a notification appearing on the screen of the candidate's computing device within the Job Posting Platform or it may be sent by email or text message or by other means of sending notifications commonly known in the art. This additional information may be in the form of submission of an introduction video, selection of dates and times for a video or phone interview, or submission of other materials supporting their application. Once the additional information is received, the candidate is then either approved by an administrative user to move on to the next steps in the hiring process or rejected.

In embodiments of the present invention, the external job candidate can view the team profile prior to applying for the job. In some embodiments the external job candidate has full access to the team profile prior to applying for the job. In other embodiments the external job candidate has limited access to the team profile prior to applying for the job. Limited access may, for example, be in the form of access to view only the team members' titles, job descriptions and the relation of their roles to other team members. However, the job application system's administrative user can customize the levels of access that job candidates have to the team profile and define what aspects of the team profile are accessible prior to submitting an application.

An internal job candidate is an employee in a different role within the organization who may want to switch roles thereby switching teams within the organization. An internal job candidate views a job posting comprising of textual content and a team profile. The job posting is accessible on an internal job hoard or provided to employees via other means commonly known in the art. The candidate submits an application for the job 110 which is either denied 112 or accepted 114 based on certain preset prescreening criteria. If the application is accepted 114, the candidate is invited to provide additional information to the administrative user 122. This may be in the form of an introduction video, selection of dates and times for a video or phone interview, or submission of other materials supporting their application. Once the additional information is received, the candidate is then either approved to move on to the next steps in the hiring process or rejected.

A current employee may refer an external or an internal candidate thy a role. The employee shares the role with the candidate using a referral link that is unique to that employee. This could be done using UTM tags or other similar means of tracking a referral source commonly known in the art. Depending on whether the referred candidate is an internal candidate or an external candidate, they would then go through the steps as disclosed above, accordingly.

The system and method are managed by an administrative user. The administrative user being the entity managing the hiring process. The administrative user preferably accesses the system and method via a software as a service administrator portal. The team profiles are manually set up via the administrator portal, however certain information may be automatically populated into the team profiles from information provided by team members at the time of employment whether through information obtained during the interview process or during onboarding. The team profiles are continuously updated, throughout the duration of the team members' employment, either manually or automatically to reflect professional and social achievements, new projects worked on, and the like.

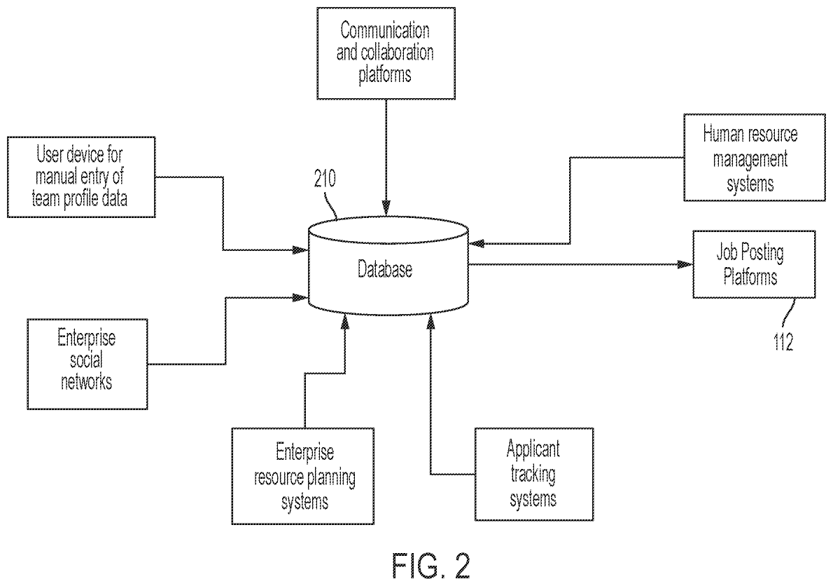

Turning now to FIG. 2, which shows an exemplary system architecture for implementing the present system and method. Team profiles are stored in one or more databases 210 which may be cloud based databases or traditional databases. The team profiles are accessed by the Job Posting Platforms 211 by way of application programming interface (API) calls. Data not collected during the hiring process may be manually entered into the team profiles upon hire or at any point thereafter but may also be automatically populated with information stored in enterprise social networks, enterprise resource planning systems and human resource management systems using APIs or other means known in the art. Team profiles may be accessed at any time internally for purposes of updating information or sending a link to these profiles for resource allocation and tracking purposes.

The present invention allows teams to communicate with the test of the organization. For example, a team may use their team profile to publicize hiring or project needs to the rest of the organization allowing interested employees to reach out to that team. On the other hand, an employee on a different team may discover a project of interest that another team is working on, through viewing that team's team profile. This facilitates employee skill matching, project coordination and general resource allocation within large, multi-dimensional nationwide or international organizations.

The present invention includes software which may either be loaded onto a computer or accessed by a computer. The loaded software may include an application on a smart device. A computer may access the software via a web browser using the internet, extranet, intranet, host server, internet cloud and the like.

The system and method described herein is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail.

It is further contemplated that the present invention may be run on a stand-alone computer system or may be ran from a server computer system that can be accessed by a plurality of client computer systems interconnected over an intranet network, or that is accessible to clients over the Internet.

To the extent the present invention discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

What is claimed is:

1. A system comprising:
a. one or more databases each storing a plurality of team profiles; and
b. a job application system comprising:
i. one or more memories storing instructions; and
ii. one or more processors coupled to the one or more memories wherein the one or more processors arc configured by the instructions to:
a) receive an application from a job candidate for an open position in response to a job posting, the job posting accessible on a job posting platform accessible on a personal computing device connected to an electronic network, wherein the job posting comprises textual content and graphic content;
b) using a prescreening algorithm, decide a route for the application based on preset prescreening criteria; and
c) notify the job candidate on the decided route for the application wherein the decided route may either be an accepted application or a rejected application.

2. The method of claim 1, wherein the graphic content comprises one or more pictorial interactive organizational charts.

3. The system of claim 1 where the decided route is an accepted application, the processer is further configured by the instructions to provide the candidate access to a team profile wherein the team profile comprises one or more pictorial interactive organizational charts.

4. The system of claim 3, wherein the processor is further configured by the instructions to receive from the job candidate input in the form an approval or a rejection of the option to proceed with the job application process.

5. The system of claim 4, where the input from the job candidate is an approval, the processor further configured by the instructions to invite the job candidate to provide additional input.

6. A method comprising:
receiving an application from a job candidate for an open position in response to a job posting, the job posting accessible on a job posting platform accessible on a personal computing device connected loan electronic network, wherein the job posting comprises textual content and graphic content;
using a prescreening algorithm, deciding a route for the application based on preset prescreening criteria;
notifying the job candidate on the decided route for the application wherein the decided route may either be an accepted application or a rejected application.

7. The method of claim 6, wherein the graphic content comprises one or more pictorial interactive organizational charts.

8. The method of claim 7, where the decided route is an accepted application, the method further comprising providing access to a team profile, wherein the team profile comprises one or more pictorial interactive organizational charts.

9. The method of claim 8, further comprising receiving from the job candidate input n the form an approval or a rejection of the option to proceed with the job application process.

10. The method of claim 9, wherein the input from the job candidate is an approval, the method further comprising inviting the job candidate to provide additional input.
